(19) United States
(12) Patent Application Publication
(10) Pub. No.: US 2016/0129633 A1
(43) Pub. Date: May 12, 2016

(54) THREE DIMENSIONAL PRINTING APPARATUS AND THREE DIMENSIONAL PRINTING METHOD

(71) Applicants: XYZprinting, Inc., New Taipei City (TW); Kinpo Electronics, Inc., New Taipei City (TW); Cal-Comp Electronics & Communications Company Limited, New Taipei City (TW)

(72) Inventor: Yao-Te Huang, New Taipei City (TW)

(21) Appl. No.: 14/604,763

(22) Filed: Jan. 26, 2015

(30) Foreign Application Priority Data
Nov. 11, 2014 (CN) 201410631452.X

(51) Int. Cl. B29C 67/00

(52) U.S. Cl. CPC B29C 67/0062; B33Y 30/00

(57) ABSTRACT

The disclosure provides a 3D printing apparatus and a 3D printing method which form a 3D object by forming and stacking a plurality of forming layers. The 3D printing apparatus includes a body, a printing module, a curing module, a sensing module and a controlling module. The body has a stage. The printing module sprays liquid forming material on the stage. The curing module cures the liquid forming material on the stage to form a forming layer. The sensing module is configured corresponding to the stage and detects a surface profile of the forming layer according to a condition parameter to generate a profile signal. The controlling module is electrically connected to the printing module, sensing module and curing module. The controlling module receives the profile signal and drives the printing module and the curing module according to the profile signal to remedy the surface profile of the forming layer.

### CROSS-REFERENCE TO RELATED APPLICATION

This application claims the priority benefit of Chinese application serial no. 201410631452.X, filed on Nov. 11, 2014. The entirety of the above-mentioned patent application is hereby incorporated by reference herein and made a part of this specification.

### BACKGROUND

1. Technical Field

The technical field relates to a three dimensional (3D) printing apparatus and a 3D printing method.

2. Description of Related Art

With advancement in computer-aided manufacturing (CAM), a three dimensional (3D) printing technology has been developed in the manufacturing industry, which can very quickly fabricate a physical solid object based on an original concept design. The 3D printing, in fact, is a general term for a series of rapid prototyping technologies (i.e. RP) and the concept thereof is a laminate manufacturing, where an RP machine scans a prototype work piece along an X-Y plane to obtain a cross-section shape of the work piece. Meanwhile, the probe intermittently displaces in Z coordinate with a step of a slice thickness layer by layer so as to ultimately form the 3D object. The 3D printing is unrestricted to the geometric shapes with the prototype, and the more complex the work piece is, the more excellences the RP technology shows so as to largely save the labor and the process time. As a result, a digital 3D model given by the computer-aided design (CAD) can be truthfully revealed under the shortest time requirement, and the model is, not only palpable, but also truly felt for its geometric curves. The user can trial the assembling performance of the model, and even can do possible functional test thereof.

At present, many techniques for forming thin cross-sectional layers have been developed. For example, a printing module is usually configured to move above a base along coordinates X-Y according to coordinates X-Y-Z constructed according to the design data of a 3D model, so as to form shapes of the cross-sectional layers accurately by spraying a construction material. Then, the deposited material gets naturally hardened or cured by using, for example, a strong light source so as to form the required cross-sectional layers, followed by curing layer by layer to form a 3D object. The forming approach varies depending on the material property. For example, for a fusing/softening plastic material to serve as the “ink” of the 3D printing, the RP technique can adopt, for example, the selective laser sintering (SLS) and the fused deposition modeling (FDM).

However, in the process of stacking the liquid forming material to form an object, a void is likely to be formed between “ink drop” and “ink drop” due to surface tension, causing structural defects to be formed in the cured forming material which may even collapse after being stacked in layers as well as causing unevenness in the surface of the 3D object. Accordingly, it remains to be an issue for persons in the art to reduce the abovementioned structural defects during the 3D printing process.

### SUMMARY

The disclosure provides a 3D printing apparatus and a 3D printing method, which apply a means for flattening at least one forming layer during the process of forming a 3D object, so as to eliminate the structural defect thereof.

In the disclosure, the 3D printing apparatus forms the 3D object by forming and stacking a plurality of forming layers. The 3D printing apparatus includes a body, a printing module, a curing module, a sensing module and a controlling module. The body has a stage. The printing module sprays liquid forming material on the stage. The curing module cures the liquid forming material on the stage to form a forming layer. The controlling module is electrically connected to the printing module, sensing module and the curing module. The sensing module is configured corresponding to the stage, and detects a surface profile of the forming layer according to a condition parameter to generate a profile signal. The control module receives the profile signal and drives the printing module and the curing module according to the profile signal to remedy the surface profile of the forming layer.

In the disclosure, the 3D printing method forms a 3D object. The 3D printing method includes providing a plurality of forming layers on the stage layer by layer, and constructing a 3D object by stacking the forming layers; sensing the surface state of the forming layer according to a condition parameter in the process of forming the forming layer; and when the forming layer is found to have at least one recess, spraying the liquid forming material in the recess to remedy the forming layer.

Based on the above, in exemplary embodiments of the disclosure, the 3D printing apparatus and the 3D printing method apply a flattening means to at least one of the forming layers during the process of forming the 3D object by stacking a plurality of forming layers layer by layer. In other words, the forming layer is detected by the sensing module within a predetermined time interval. Under the circumstances where the forming layer is found to have a recess, the controlling module drives the printing module to provide a liquid forming material in the recess by accepting the profile signal generated by the sensing module, such that the curing module cures the liquid forming material to fill the recess. Accordingly, the void caused by surface tension of the liquid forming material may be removed effectively, eliminating the worry that the overall structural strength will be affected due to change in the material state during the forming process of the 3D object.

In order to make the aforementioned features and advantages of the disclosure more comprehensible, embodiments accompanying figures are described in detail below.

### BRIEF DESCRIPTION OF THE DRAWINGS

FIG. 1 is a schematic view illustrating a 3D printing apparatus according to an exemplary embodiment of the disclosure.

FIG. 2 is a local enlargement illustrating the 3D printing apparatus according to FIG. 1.

FIG. 3 is a schematic view illustrating a state in which the 3D printing apparatus of FIG. 1 is printing.

FIG. 4 is a flowchart illustrating 3D printing according to an exemplary embodiment of the disclosure.

FIG. 5 is another schematic view illustrating a state in which a 3D printing apparatus of another exemplary embodiment of the disclosure is printing.

FIG. 6 is a local enlargement illustrating a 3D printing apparatus according to another exemplary embodiment of the disclosure.

### DESCRIPTION OF EMBODIMENTS

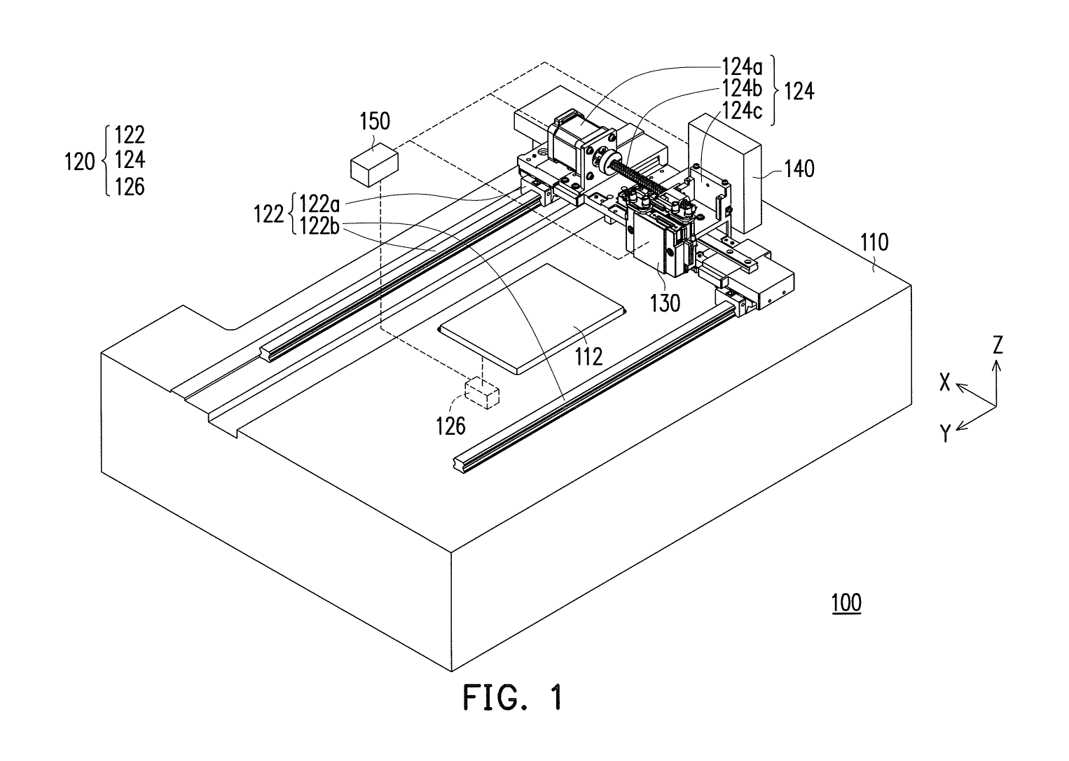

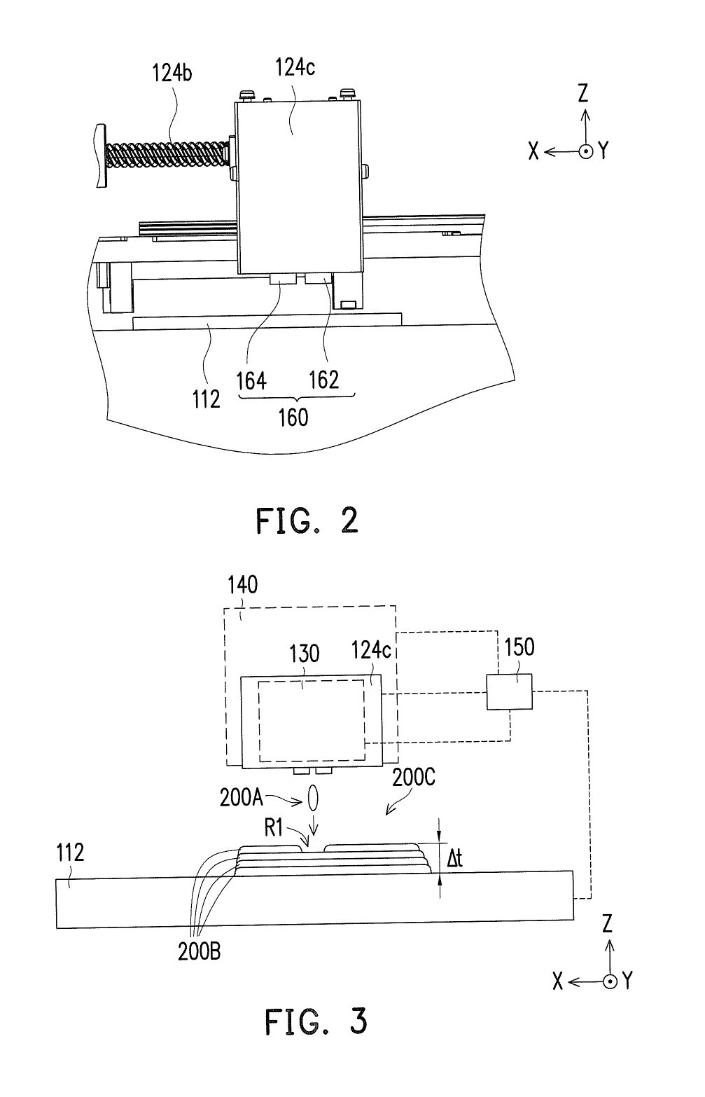

FIG. 1 is a schematic view illustrating a 3D printing apparatus according to an exemplary embodiment of the disclosure. FIG. 2 is a local enlargement illustrating the 3D printing apparatus according to FIG. 1. FIG. 3 is a schematic view illustrating a state in which the 3D printing apparatus of FIG. 1 is printing. Please refer to FIGS. 1-3. In the exemplary embodiment, a 3D printing apparatus 100 is adaptable for printing a 3D object according to digital 3D model information. The digital 3D model information may be a digital 3D image file which is, for example, constructed by a computer host using computer-aided design (CAD) or animation modeling software, through which the 3D printing process is performed via related controlling components of the 3D printing apparatus 100. The 3D printing apparatus 100 includes a body 110, a transmission module 120, a printing module 130, a curing module 140, a controlling module 150 and a sensing module 160. The body 110 includes a lifting stage 112 used for being positioned and supporting the 3D object. The transmission module 120 is configured on the body 110; the controlling module 150 is electrically connected to the transmission module 120, the printing module 130, the curing module 140, the sensing module 160, and the lifting stage 112.

In the exemplary embodiment, the transmission module 120 includes a plurality of driving assemblies 122, 124 and 126, wherein the driving assembly 122 includes a driving member 122a and a track 122b, and the driving member 122a is movably configured on the track 122b to move along a Y-axis. The driving assembly 124 is configured on the driving member 122a to move along the Y-axis. In the meantime, the driving assembly 124 includes a driving member 124a, a screw rod 124b and a supporting member 124c, wherein the supporting member 124c is movably coupled to the screw rod 124b so that the driving member 124a (e.g. a motor) can drive the supporting member 124c to move along a X-axis while driving the screw rod 124b to rotate about the X-axis. The driving assembly 126 is configured within the body 110 and connected to the lifting stage 112 for driving the lifting stage 112 to move along a Z-axis. Please note that the transmission module 120 disclosed herein is just one of the exemplary embodiments; all the known transmission mechanisms that can drive the printing module 130, the curing module 140, the sensing module 160 and the lifting stage 112 as well as related moving components mentioned subsequently are applicable to the disclosure.

The printing module 130 and the curing module 140 are respectively assembled at two opposite sides of the supporting member 124c along the Y-axis and, as described above, the driving assemblies 122 and 124 of the transmission module 120 can control the printing module 130 and the curing module 140 to move along the X-Y plane while performing driving. Furthermore, the lifting stage 112 is positioned within a range where the controlled printing module 130 and the curing module 140 move. Therefore, after the controlling module 150 receives the digital 3D model information, the liquid forming material is sprayed on the lifting stage 112 by the printing module 130, cured by the curing module 140 to form a forming layer, and moves together with the lifting stage 112 along the Z-axis so the forming layer can be stacked layer by layer until the desired 3D object is finally completed.

FIG. 4 is a flowchart illustrating 3D printing according to an exemplary embodiment of the disclosure. Please refer to FIGS. 3-4 both. In the exemplary embodiment, a forming material 200A is, for example, a liquid photopolymer, which is sprayed on the lifting stage 112 by the printing module 130 and cured to form a forming layer 200B by the curing module 140, such as an ultraviolet light source. Thereafter, by performing spraying and curing in the same manner mentioned above, the forming layer can be stacked layer by layer to form a 3D object 200C.

In the meantime, as indicated above, when the forming material 200A has not be cured to form the forming layer, a void is likely to be formed between liquid drops due to surface tension. In that case, the 3D printing apparatus 100 in the exemplary embodiment will scan the forming layer 200B via the sensing module 160 according to a condition parameter to sense the surface state of the forming layer 200B. In the exemplary embodiment, the condition parameter is a predetermined time Δt; in other exemplary embodiments that are not shown, the condition parameter may be a certain layer or structural height of the formed forming layer 200B, which can be correspondingly adjusted depending on the needs.

In the exemplary embodiment, the sensing module 160 is formed of an image sensor 162 (e.g. CCD or CMOS) and an infrared sensor 164. The image sensor 162 senses the image of the surface of the forming layer 200B, and the infrared sensor 164 senses the surface profile of the forming layer 200B, i.e. the waviness state of the surface terrain. Accordingly, when the infrared sensor 164 senses that a recess R1 is formed in the surface of the forming layer 200B, the image sensor 162 can sense the position of the recess R1 at the same time. As shown by FIG. 3, it is obvious that a void is formed between liquid drops in the forming layer 200B at the top. At this time, if the liquid forming material 200A is continuously sprayed and cured regardless of the void, the void will ultimately become a structural defect; in that case, the structural strength at that area of the 3D object 200C will cause concern.

Based on the above, the 3D printing method of the disclosure is described in details as follows.

First of all, in step S410 of the exemplary embodiment, the liquid forming material 200A is sprayed on the lifting stage 112 via the printing module 130 and cured via the curing module 140 to form the forming layer 200B. Next, in step S420, the above spraying and curing actions are performed repeatedly to stack a plurality of forming layers 200B layer by layer until a 3D object 200C is finally completed. Please note that, in the forming process of the forming layer 200B in step S430, the surface of the forming layer 200B is detected by the sensing module 160 according to the condition parameter to determine whether the recess R1 is formed in the surface. If no recess R1 is formed, the spraying and curing actions in the step S420 will be performed continuously until the 3D object 200C is completed. On the other hand, if the sensing module 160 detects that the recess R1 is formed, the depth and range of the recess R1 detected by the infrared sensor 164 and the position of the recess R1 detected by the image sensor 162 will be provided back to the controlling module 150. Thereafter, in step S440, the controlling module 150 will drive the printing module 130 to further provide the liquid forming material 200A in the recess R1 to be cured by the curing module 140 so as to fill the recess R1. When the forming layer 200B is no longer found to have the recess R1, the actions performed in the step S420 will continue.

As described above, the disclosure provides no limitation to the form of the condition parameter, which may vary depending on related forming conditions such as material, curing light source, printing accuracy and the like. Accordingly, as shown by the exemplary embodiment of FIG. 3, counting from the time when the forming layer 200B starts to be formed on the stage 112, it is set to detect the surface of the forming layer 200B within a predetermined time Δt. At this time, the sensing module 160 detects the surface profile of the fourth layer of the forming layer 200B. Certainly, the user may set the predetermined time Δt and layer as well as time interval or layer interval for performing repeated detection based on related needs. Furthermore, the condition parameter serving as a basis may also be a structural height of the forming layer 200B, e.g. the height of the forming layer 200B with respect to the lifting stage 112, or the difference between the height of the forming layer 200B in the forming process with respect to the predetermined height of the completed 3D object 200C, such that it can be determined whether the recess R1 is formed in the forming layer 200B and a corresponding action can be performed accordingly. In that case, the efficiency and yield rate of the 3D printing process can be optimized.

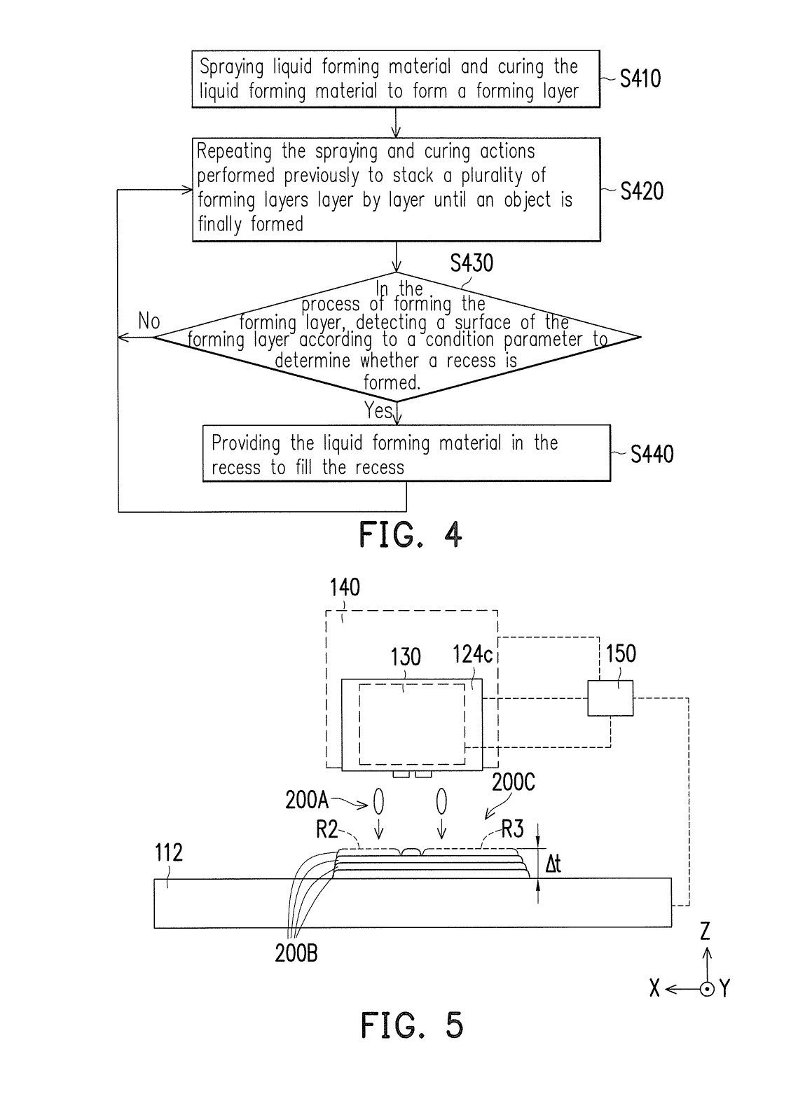

FIG. 5 is another schematic view illustrating a state in which a 3D printing apparatus of another exemplary embodiment is printing. Here, the schematic view illustrates another type of 3D printing process; that is, the sensing module 160 detects that more than one recess is formed when detecting the surface profile of the forming layer 200B. As shown by FIG. 5, two recesses R2 and R3 are formed in the forming layer 200B at the top. Likewise, the sensing module 160 generates a profile signal to be transmitted to the controlling module 150 such that the controlling module 150 drives the printing module 130 and the curing module 140 to spray and cure the liquid forming material 200A in the recesses R2 and R3 to remedy the recesses R2 and R3.

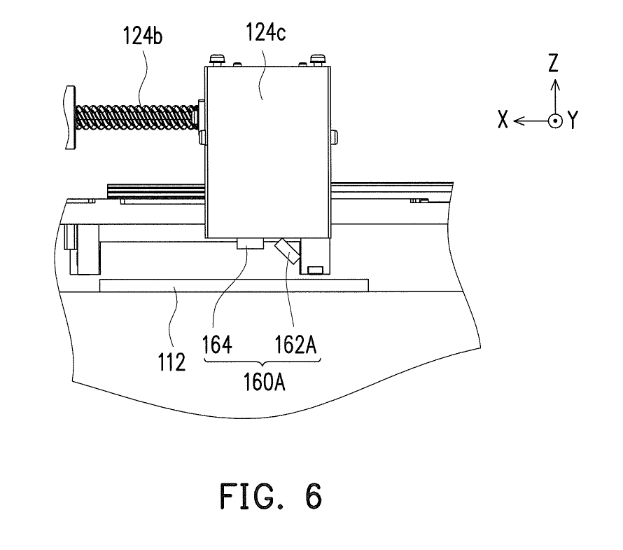

FIG. 6 is a local enlargement illustrating a 3D printing apparatus according another exemplary embodiment. Different from the previous exemplary embodiments, a sensing module 160A in the exemplary embodiment includes two image sensors 162A and 164, and an angle is formed between the two image sensors 162A and 164. Here, the description “the angle is formed” indicates that each of the image sensors 162A and 164 are not configured on the same plane with respect to the forming layer 200B, which means that each of the image sensors 162A and 164 senses the surface profile of the forming layer 200B from different viewing angles. Accordingly, with the actions performed by the two image sensors 162A and 164, the surface image of the forming layer 200B may be identified simultaneously; meanwhile, the surface profile (i.e. waviness of the terrain) of the forming layer 200B can be constructed as well. Therefore, the exemplary embodiment may also achieve the effect of detecting the recess R1. Here, the embodiment provides no limitation to the amount of the image sensors. In another exemplary embodiment which is not shown, the accuracy of the surface profile of the forming layer 200B may be increased by using a plurality of image sensors.

Moreover, in the above exemplary embodiments, the sensing module 160 (or 160A) is substantially configured at the bottom of the supporting member 124C to move together with the printing module 130 and curing module 140 on the body 110 via the driving assemblies 122 and 124 so as to sense the forming layer 200B on the lifting stage 112; however, the disclosure provides no limitation to the position of the sensing module. In another exemplary embodiment which is not shown, under the circumstances where the sensing module does not interfere with the driving assembly and the printing module or curing module thereon, the sensing module may also achieve the same effect as described above by being fixed on the body next to the lifting stage.

Based on the above, in the above-mentioned exemplary embodiments of the disclosure, during the process of stacking forming layers layer by layer to form the 3D object, the forming layer is detected by the sensing module to make sure that, once the forming layer is found to have the recess, the controlling module will drive the printing module to provide the liquid forming material in the recess so as to fill the recess, such that the void caused by surface tension of the liquid forming material can be eliminated effectively. In the meantime, the sensing module may be formed of an infrared sensor and an image sensor, and may be provided with at least two image sensors with an angle formed in between so as to construct the surface profile of the forming layer.

In that case, since the sensing module can detect the structural defect that may be caused by the liquid forming material, and the controlling module can further fill the forming layer in a subsequent step to remedy the defect, it can be certain that, during the process of forming the 3D object, there is no need to worry about that the overall structural strength will be affected due to the change of the material state.

Finally, it should be indicated that the above-mentioned exemplary embodiments are provided only to exemplify the technical solution of the disclosure rather than to be restrictive to the disclosure. Although the invention has been disclosed by the above embodiments, the embodiments are not intended to limit the invention. It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A three-dimensional (3D) printing apparatus constructing a 3D object by forming and stacking a plurality of forming layers, comprising:
a body having a stage;
a printing module spraying a liquid forming material on the stage;
a curing module curing the liquid forming material on the stage to form the forming layers;
a sensing module configured corresponding to the stage, the sensing module detecting a surface profile of the at least one forming layer according to a condition parameter to generate a profile signal; and
a controlling module electrically connected to the printing module, the sensing module and the curing module, the controlling module receiving the profile signal and driving the printing module and the curing module according to the profile signal to remedy the surface profile of the forming layer.

2. The 3D printing apparatus as claimed in claim 1, wherein the sensing module comprises:
an image sensor sensing a surface image of the forming layer; and
an infrared sensor sensing the surface profile of the forming layer.

3. The 3D printing apparatus as claimed in claim 1, wherein the sensing module comprises:
a first image sensor; and
a second image sensor, an angle formed between the second image sensor and the first image sensor, the first image sensor and the second image sensor being controlled by the controlling module to construct the surface profile and the surface image of the forming layer.

4. The 3D printing apparatus as claimed in claim 1, further comprising:
a transmission module configured on the body and electrically connected to the controlling module, the printing module configured on the transmission module to move together with the transmission module with respect to the body, the stage located within a range where the printing module moves.

5. The 3D printing apparatus as claimed in claim 4, wherein the sensing module is configured on the transmission module and moves together with the transmission module with respect to the body, the stage is located within a range where the sensing module moves.

6. The 3D printing apparatus as claimed in claim 1, wherein the sensing module is configured next to the stage, and when the sensing module senses that at least a recess is formed in the forming layer, the sensing module generates the profile signal.

7. The 3D printing apparatus as claimed in claim 1, wherein the condition parameter comprises a time of forming the forming layers, a layer or a structural height of the forming layers.

8. A 3D printing method for forming a 3D object, comprising steps of:
providing a plurality of forming layers on a stage layer by layer, and stacking the forming layers to construct the 3D object;
sensing a surface profile of the at least one forming layer according to a condition parameter in the process of forming the forming layers; and
when it is detected that at least a recess is formed in the forming layer, spraying a liquid forming material in the recess to be cured to remedy the forming layer.

9. The 3D printing method as claimed in claim 8, wherein the step of sensing a surface state of the forming layers comprises:
providing an image sensor and an infrared sensor such that the image sensor senses a surface image of the forming layers and the infrared sensor senses a surface profile of the forming layers.

10. The 3D printing method as claimed in claim 8, wherein the step of sensing a surface state of each of the forming layers comprises:
providing at least two image sensors, and the at least two image sensors are configured to have an angle formed therebetween so as to sense and construct a surface profile and a surface image of the forming layer.

11. The 3D printing method as claimed in claim 8, wherein the condition parameter comprises a time of forming the forming layers, a layer or a structural height of the forming layers.
